(19) United States
(12) Patent Application Publication
(10) Pub. No.: US 2021/0229446 A1
(43) Pub. Date: Jul. 29, 2021

(54) Inkjet Recording Device

(71) Applicant: Hitachi Industrial Equipment Systems Co., Ltd., Chiyoda-ku, Tokyo (JP)

(72) Inventors: Shoki YAMAGUCHI, Tokyo (JP); Takahiro ARIMA, Tokyo (JP); Sho MIZOGUCHI, Tokyo (JP); Mamoru OKANO, Tokyo (JP); Akira MIYAO, Tokyo (JP)

(21) Appl. No.: 15/734,018

(22) PCT Filed: Jan. 24, 2019
(86) PCT No.: PCT/JP2019/002205

§ 371 Date: Dec. 1, 2020

(30) Foreign Application Priority Data
Jun. 6, 2018 (JP) 2018-108347

(51) Int. Cl. B41J 2/165

(52) U.S. Cl. CPC B41J 2/16552; B41J 2/16508

(57) ABSTRACT

An object of the present invention is to provide an inkjet recording device having a print head cleaning function of preventing a cleaning liquid from spilling around the inkjet recording device and storing the cleaning liquid used for cleaning in a highly airtight container. In order to realize the foregoing object, the inkjet recording device includes a main body including an ink container that accommodates an ink used to perform printing on a print target, and a cleaning liquid container that accommodates a cleaning liquid; a print head including a nozzle that is connected to the ink container to discharge the ink which is pressurized and supplied, a charging electrode that charges ink particles to be used for the printing, a deflection electrode that deflects the ink particles charged by the charging electrode, and a gutter that recovers the ink particles which are not used for the printing; and a head cleaning unit including a cleaning nozzle that discharges the cleaning liquid, and an insertion port into which the print head is insertable.

### TECHNICAL FIELD

The present invention relates to a head cleaning function of an inkjet recording device.

### BACKGROUND ART

JP 2015-136934 A (Patent Document 1) discloses the background art relating to the technical field. In a method for cleaning a head of an inkjet recording device disclosed in Patent Document 1, cleaning is performed by ejecting a cleaning liquid toward a nozzle discharge port from a cleaning nozzle inside a head. There is disclosed that the cause of occurrence of nozzle clogging is eliminated by then performing a drying step.

### CITATION LIST

### Patent Document

Patent Document 1: JP 2015-136934 A

### SUMMARY OF THE INVENTION

### Problems to be Solved by the Invention

In the method disclosed in Patent Document 1, when the cleaning liquid is ejected toward the nozzle discharge port from the cleaning nozzle inside the head, there is a possibility that the cleaning liquid spills outside the head.

In many cases, the inkjet recording device is used in production lines for producing foods, drinking water, drugs, and cosmetics where hygiene control is crucial. For this reason, the cleaning liquid or an ink is required to not spill to equipment, a floor, or the like inside or around the inkjet recording device.

Therefore, an object of the present invention is to provide an inkjet recording device having a print head cleaning function of preventing a cleaning liquid from spilling around the inkjet recording device and storing the cleaning liquid used for cleaning in a highly airtight container.

### Solutions to Problems

In light of the background art, according to one example of the present invention, there is provided an inkjet recording device including: a main body including an ink container that accommodates an ink used to perform printing on a print target, and a cleaning liquid container that accommodates a cleaning liquid; a print head including a nozzle that is connected to the ink container to discharge the ink which is pressurized and supplied, a charging electrode that charges ink particles to be used for the printing, a deflection electrode that deflects the ink particles charged by the charging electrode, and a gutter that recovers the ink particles which are not used for the printing; and a head cleaning unit including a cleaning nozzle that discharges the cleaning liquid, and an insertion port into which the print head is insertable.

### Effects of the Invention

According to the present invention, it is possible to provide an inkjet recording device including a head cleaning unit for a print head which is capable of preventing a cleaning liquid from spilling around the inkjet recording device and eliminating the cause of nozzle clogging.

### BRIEF DESCRIPTION OF THE DRAWINGS

FIG. 1 is a perspective view illustrating a state of use of an inkjet recording device in a first embodiment.

FIG. 2 is a diagram illustrating a path configuration of the inkjet recording device in the first embodiment.

FIG. 3 is a cross-sectional view of a head cleaning unit in the first embodiment.

FIG. 4 is a cross-sectional view of the head cleaning unit into which a print head in the first embodiment is inserted.

FIG. 5A is a cross-sectional view illustrating a state of connection between the head cleaning unit and a waste liquid container in the first embodiment.

FIG. 5B is a cross-sectional view illustrating a state where the waste liquid container is removed from the head cleaning unit in the first embodiment.

FIG. 6 is a flowchart of an operation of the head cleaning unit in the first embodiment.

FIG. 7 is a perspective view illustrating an operation principle of the inkjet recording device.

FIG. 8 is a cross-sectional view of a head cleaning unit in a second embodiment.

FIG. 9 is a cross-sectional view of a head cleaning unit in a third embodiment.

### MODE FOR CARRYING OUT THE INVENTION

Hereinbelow, embodiments of the present invention will be described with reference to the drawings.

### First Embodiment

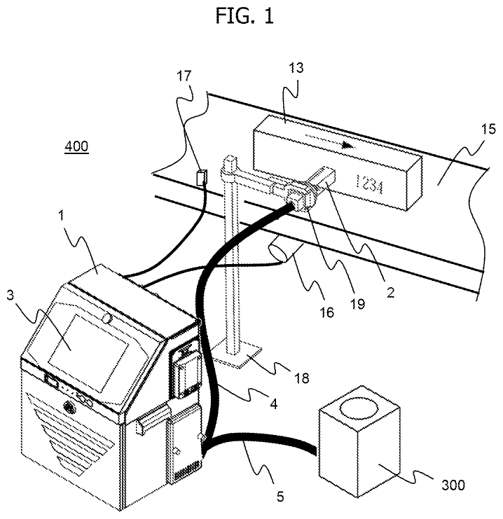

FIG. 1 is a perspective view illustrating a state of use of an inkjet recording device 400 in the present embodiment. In FIG. 1, reference numeral 1 denotes an inkjet recording device main body, reference numeral 2 denotes a print head, reference numeral 3 denotes an operation display unit, reference numeral 4 denotes a conduit (for the print head), reference numeral 5 denotes a conduit (for a head cleaning unit), and reference numeral 300 denotes the head cleaning unit (external unit). In the inkjet recording device 400, the inkjet recording device main body 1 includes the operation display unit 3, the print head 2 and the head cleaning unit 300 are externally provided, the inkjet recording device main body 1 and the print head 2 are connected to each other via the conduit 4 of approximately 3,000 mm in length, and the inkjet recording device main body 1 and the head cleaning unit 300 are connected to each other via the conduit 5 of approximately 3,500 mm in length.

In addition, reference numeral 13 denotes a print target on which numbers or characters are to be printed, reference numeral 15 denotes a belt conveyor that transports the print target 13, reference numeral 16 denotes a rotary encoder that measures the transport distance of the belt conveyor 15, reference numeral 17 denotes a print sensor, reference numeral 18 denotes a stand that fixes the print head in a random posture, and reference numeral 19 denotes a fixing jig that fixes the print head 2 to the stand 18.

For example, the inkjet recording device 400 is installed in a production line in a factory where foods, beverages, or the like are produced. The inkjet recording device main body 1 is installed at a position where a user can operate the inkjet recording device main body 1. The print head 2 is installed at a position where the print head 2 can be close to the print target 13 which is fed on the production line such as the belt conveyor 15. In this case, the print head 2 may be fixed to the stand 18 on which the fixing jig 19 is to be mounted. The encoder 16 that outputs a signal corresponding to a feed speed to the inkjet recording device 400 in order to print numbers or characters in an equally spaced manner regardless of the feed speed, or the print sensor 17 that detects the print target 13 to output a print instruction signal to the inkjet recording device 400 is installed on the production line such as the belt conveyor 15, and the encoder 16 and the print sensor 17 are connected to a control unit (not illustrated) inside the inkjet recording device main body 1. The control unit controls the amount of charge into or the timing to charge ink particles discharged from a nozzle, according to the signal from the encoder 16 or the print sensor 17, to perform printing in such a manner as to cause the charged and deflected ink particles to adhere to the print target 13 while the print target 13 passes through the vicinity of the print head 2.

The head cleaning unit 300 is installed close to the print head 2. In this case, the conduit 5 is set to be longer than the conduit 4 to allow the degree of freedom in the installation of the head cleaning unit 300. When the print head is to be cleaned and dried, the print head 2 is installed in the head cleaning unit 300. Then, air and a solvent (hereinafter, also referred to as a cleaning liquid) delivered from the inkjet recording device main body 1 to the head cleaning unit 300 through the conduit 5 is discharged from a nozzle inside the head cleaning unit to clean and dry the print head 2.

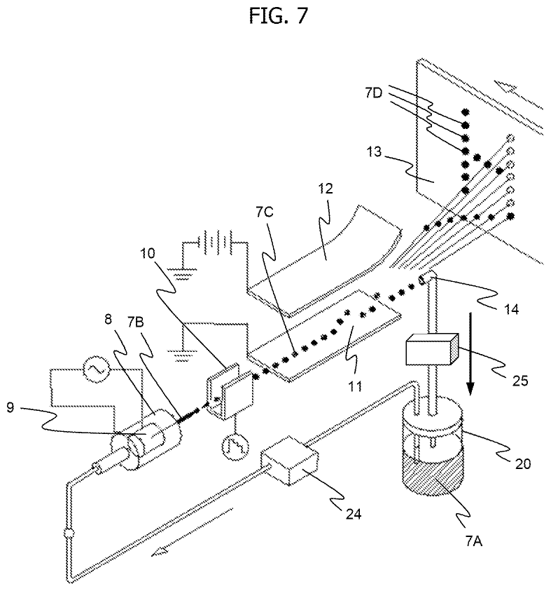

Subsequently, an operation principle of the inkjet recording device will be described with reference to FIG. 7. In FIG. 7, reference numeral 20 denotes a main ink container, reference numeral 7A denotes an ink, reference numeral 24 denotes a pump (for supply) that pressurizes and delivers the ink, 9 denotes an electrostrictive element that vibrates at a predetermined frequency when a voltage is applied to the electrostrictive element, reference numeral 8 denotes a nozzle that discharges an ink, and reference numeral 7B denotes an ink column. Reference numeral 10 denotes a charging electrode that charges ink particles, reference numeral 7C denotes ink particles, reference numeral 11 denotes ground deflection electrode, reference numeral 12 denotes a positive deflection electrode, reference numeral 13 denotes the print target, and reference numeral 14 denotes a gutter that recovers ink particles which are not used for printing.

The ink 7A in the main ink container 20 is suctioned and pressurized by the pump 24 (for supply) to be discharged from the nozzle 8 as the ink column 7B. The nozzle 8 includes the electrostrictive element 9, and vibrates the ink at a predetermined frequency to atomize the ink column 7B discharged from the nozzle 8. The number of the ink particles 7C generated in this manner is determined by the frequency of an excitation voltage applied to the electrostrictive element 9, and is the same number as the frequency. A voltage of a magnitude corresponding to print information is applied to the charging electrode 10, so that an electric charge is given to the ink particles 7C.

The ink particles 7C charged by the charging electrode 10 fly in an electric field between the ground deflection electrode 11 and the positive deflection electrode 12. The deflection electric field is formed between the positive deflection electrode 12 to which a high voltage of 1 to 7 kV is applied and the ground deflection electrode 11 which is installed, and the charged ink particles 7C receive a force proportional to the amount of charge to be deflected and fly toward and impact the print target 13.

In this case, since the impact positions of the ink particles 7C in a deflection direction are changed according to the amount of charge and the production line moves the print target 13 in a direction orthogonal to the deflection direction, the particles are capable of impacting the print target 13 in the direction orthogonal to the deflection direction to perform printing where a plurality of impact ink particles 7D form characters. After the ink particles 7C which are not used for printing fly linearly between the positive deflection electrodes 12 and are captured by the gutter 14, the ink particles 7C are suctioned and recovered to the main ink container 20 by a pump 25 (for recovery).

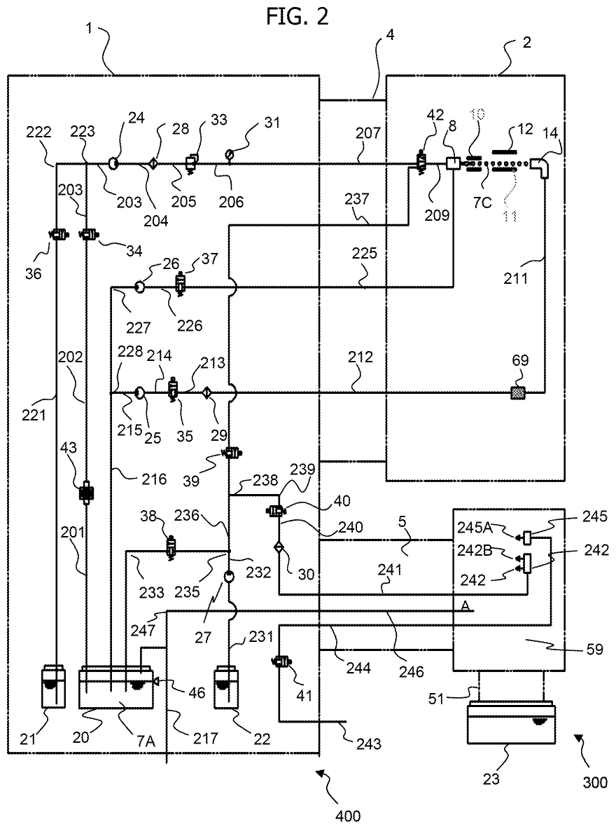

Subsequently, an ink supply path of the inkjet recording device 400 in the present embodiment will be described. FIG. 2 is a diagram illustrating a path configuration of the inkjet recording device in the present embodiment. In FIG. 2, the inkjet recording device main body 1 includes the main ink container 20 containing the ink 7A which circulates, and the main ink container 20 includes a liquid level sensor 46 that detects whether or not the liquid in the main ink container 20 reaches a reference liquid level which is an amount appropriate to be contained thereinside.

The main ink container 20 is connected via a path 201 to a viscometer 43 which measures the viscosity of the ink 7A in the main ink container 20. The viscometer 43 is connected via a path 202 to an electromagnetic valve 34 (for supply) which opens and closes a path. The electromagnetic valve 34 (for supply) is connected via a path 203 to the pump 24 (for supply) used to suction and pressure-deliver the ink 7A. Then the pump (for supply) is connected via a path 204 to a filter 28 (for supply) which removes foreign matter mixed in the ink 7A.

The filter 28 (for supply) is connected via a path 205 to a regulation valve 33 which regulates the pressure of the ink 7A, which is pressure-delivered from the pump 24 (for supply), at a pressure appropriate for printing. The regulation valve 33 includes a pressure sensor 31 which measures the pressure of the ink 7A supplied to the nozzle 8 via a path 206. The pressure sensor 31 is connected via a path 207, which passes through the conduit 4, to a switching valve 42 which controls whether or not to supply the ink 7A to the nozzle 8.

The switching valve 42 is connected via a path 209 to the nozzle 8 including a discharge port that discharges the ink 7A. Incidentally, the switching valve 42 is a three-way electromagnetic valve, and the switching valve 42 is connected to the path 207 for supplying the ink and a path 237 for cleaning to be able to switch between the supply of the ink and the supply of the solvent to the nozzle 8. The charging electrode 10 that applies a predetermined amount of charge to the ink particles 7C, the deflection electrode 12 that deflects the ink particles 7C which are to be used for printing, and the gutter 14 that captures the ink particles 7C which fly linearly without being charged and deflected due to being not used for printing are disposed in a straight direction of the discharge port of the nozzle 8.

Subsequently, an ink recovery path will be described. In FIG. 2, the gutter 14 is connected via a path 212, which passes through the conduit 4, to a filter 30 (for recovery) which is disposed inside the inkjet recording device main body 1 to remove foreign matter mixed in the ink. The filter 29 (for recovery) is connected via a path 213 to an electromagnetic valve 35 (for recovery) which opens and closes a path.

The electromagnetic valve 35 (for recovery) is connected via a path 214 to the pump 25 (for recovery) which suctions the ink particles 7C captured by the gutter 14. The pump 25 (for recovery) is connected via a path 215 and a path 216 to the main ink container 20. In addition, the main ink container 20 is connected to an exhaust path 217, and the exhaust path 217 is configured to communicate with the outside of the inkjet recording device main body 1.

Subsequently, an ink replenishment path will be described. In FIG. 2, the inkjet recording device main body 1 includes an auxiliary ink container 21 that contains an ink for replenishment, and the auxiliary ink container 21 is connected via a path 221 to an electromagnetic valve 36 which opens and closes a path. Then, the electromagnetic valve 36 is connected via a path 222 to a confluence path 223 connected to the path 203 for the supply of the ink.

Subsequently, an ink circulation path will be described. In FIG. 2, an electromagnetic valve 37 provided inside the inkjet recording device main body 1 to open and close a flow path is connected to the nozzle 8, which is provided inside the print head 2, via a path 225 other than the path 207 for the supply of the ink to pass through the conduit 4. The electromagnetic valve 37 is connected via a path 226 to a pump (for circulation) that suctions the ink from the nozzle 8. Then, the pump 26 (for circulation) is configured to be connected via a path 227 to a confluence path 228 connected to the path 215 for the recovery of the ink.

Subsequently, a solvent replenishment path will be described. In FIG. 2, the inkjet recording device main body 1 includes a solvent container 22 that contains a solvent 6 for replenishment, and the solvent container 22 is connected via a path 231 to a pump 27 (for the solvent) used to suction and pressure-deliver the solvent 6. The pump 27 (for the solvent) is connected via a path 232 and a branch path 235 to an electromagnetic valve 38 (for the replenishment of the solvent) which opens and closes a flow path. The electromagnetic valve (for the replenishment of the solvent) is connected via a path 233 to the main ink container 20.

Subsequently, a cleaning path will be described. In FIG. 2, the pump 27 (for the solvent) is connected via the branch path 235 and a path 236 in the path 232 to an electromagnetic valve 39 (for cleaning) which opens and closes a flow path. Then, the electromagnetic valve 39 (for cleaning) is configured to be connected via the path 237 to the switching valve 42 which controls whether or not to deliver the solvent for cleaning to the nozzle 8.

Subsequently, a path of the head cleaning unit will be described. In FIG. 2, the path 236 is connected via a branch path 238 and a path 239 to an electromagnetic valve 40 (for the head cleaning unit) which opens and closes a flow path, and the electromagnetic valve 40 (for the head cleaning unit) is connected via a path 240 to a filter 30 (for the head cleaning unit) which is disposed inside the inkjet recording device main body 1 to remove foreign matter mixed in the solvent. The filter 30 (for the head cleaning unit) is connected via a path 241 to a cleaning nozzle 242, and the cleaning nozzle 242 is configured to include cleaning nozzle ports 242A and 242B that discharge the solvent 6. In addition, the number of the cleaning nozzle ports is a single-digit number or a multiple-digit number.

Subsequently, a drying path will be described. In FIG. 2, a path 243 is connected to an air compressor that is externally provided to supply air. Alternatively, the path 243 is connected to a pump that is provided inside the inkjet recording device main body 1 to supply air. The path 243 is connected to an electromagnetic valve 41 (for the supply of air) that opens and closes a path, and the electromagnetic valve 41 (for the supply of air) is connected via a path 244 to a drying nozzle (air nozzle) 245. The drying nozzle 245 includes a drying nozzle port 245A that discharges air. In addition, the number of the drying nozzle ports is a single-digit number or a multiple-digit number.

Subsequently, a waste liquid path will be described. In FIG. 2, the solvent 6 discharged from the cleaning nozzle ports 242A and 242B is supplied via a container connection portion 51 to a waste liquid container 23 inside the head cleaning unit 300.

Subsequently, an exhaust path of the head cleaning unit 300 will be described. In FIG. 2, a path 246 configured to communicate with a head cleaning unit interior 59 is connected to the exhaust path 217 via a confluence path 247, which is present inside the inkjet recording device main body 1 of the inkjet recording device 400, through the conduit 5.

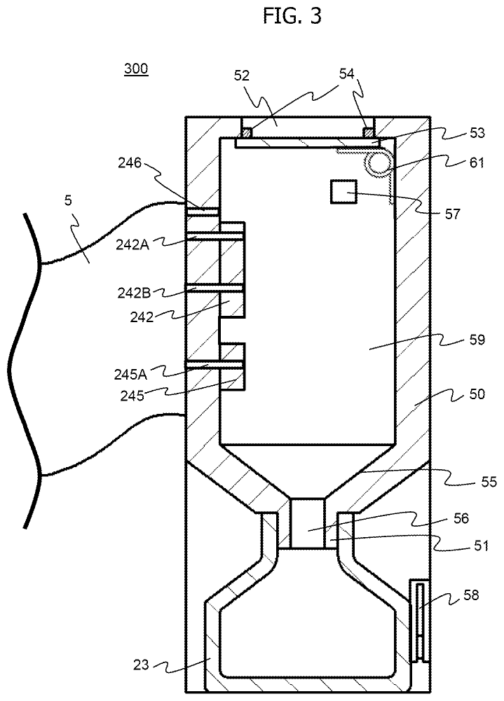

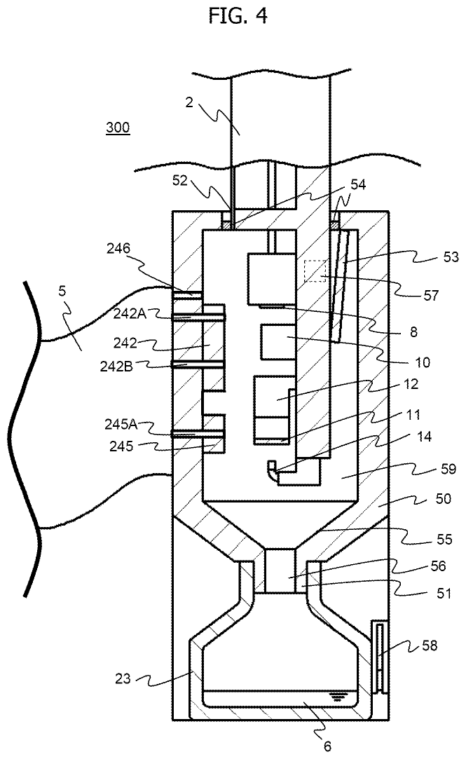

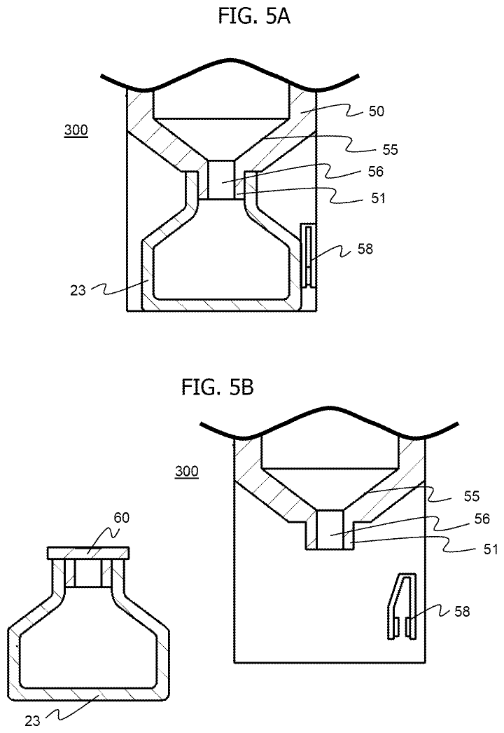

FIG. 3 is a cross-sectional view of the head cleaning unit 300 in the present embodiment. In addition, FIG. 4 illustrates a cross-sectional view of the head cleaning unit 300 into which the print head 2 in the present embodiment is inserted, and FIG. 5 is a cross-sectional view of a head cleaning unit main body 50 provided in the head cleaning unit 300 and the waste liquid container 23.

In FIGS. 3 to 5A and 5B, reference numeral 50 denotes the head cleaning unit main body, reference numeral 23 denotes the waste liquid container, reference numeral 51 denotes the container connection portion, reference numeral 52 denotes an insertion port, reference numeral 53 denotes a head cleaning unit lid portion, reference numeral 54 denotes a seal portion, reference numeral 55 denotes a solvent receiver, reference numeral 56 denotes a connection path, reference numeral 57 denotes a sensor (for the print head), reference numeral 58 denotes a sensor (for the waste liquid container), and reference numeral 60 denotes a seal plug.

Firstly, a state of use of the head cleaning unit 300 will be described with reference to FIGS. 3 to 5A and 5B. In FIG. 3, the head cleaning unit 300 includes the insertion port 52 into which the print head 2 is insertable. The insertion port 52 has a structure where when the print head 2 is not inserted into the insertion port 52, the insertion port 52 is blocked by the head cleaning unit lid portion 53 such that the atmosphere in the head cleaning unit interior 59 and outside air are not mixed together. Namely, the head cleaning unit lid portion 53 is biased by a biasing member such as a torsion coil spring 61 to close the insertion port 52. In addition, the solvent receiver 55 has a structure where the solvent 6 supplied to the head cleaning unit interior 59 is to be supplied to the connection path 56 passing through the container connection portion 51. The container connection portion 51 is detachably connected to the waste liquid container 23 such that the solvent 6 supplied to the connection path 56 is to be supplied to the waste liquid container 23 inside the head cleaning unit 300 without leaking outside. In addition, the head cleaning unit 300 includes the sensor 57 (for the print head) which is head detecting means capable of detecting whether or not the print head 2 is mounted in the head cleaning unit 300, and includes the sensor (for the waste liquid container) which is container detecting means capable of detecting whether or not the waste liquid container 23 is mounted in the head cleaning unit 300. Incidentally, the positions of the sensors 57 and 58 are not limited to the illustrated positions, and the sensors 57 and 58 may be disposed at positions where the print head 2 and the waste liquid container 23 can be detected. For example, the sensor 58 (for the waste liquid container) may be disposed at the position of the connection path 56. In addition, sensors provided in the print head 2 and the waste liquid container 23 may be used.

In FIG. 4, when the print head 2 is inserted into the head cleaning unit 300, the seal portion 54 and the print head 2 are in close contact with each other, so that the cleaning liquid is prevented from spilling from locations other than the connection path 56 and the atmosphere in the head cleaning unit interior is not mixed with the outside air. In addition, the head cleaning unit lid portion 53 has a structure where when the print head 2 is removed from the insertion port 52, the head cleaning unit lid portion 53 is biased by the biasing member to block the insertion port 52 again and thus prevent the atmosphere in the head cleaning unit interior 59 and the outside air from being mixed together. In addition, the cleaning nozzle ports 242A and 242B are provided at the positions or in the directions that allow the solvent 6 to come into contact with the nozzle 8, the charging electrode 10, the ground deflection electrode 11, the positive deflection electrode 12, and the gutter 14 which are provided in the print head 2. Furthermore, the drying nozzle port 245A is provided at the position or in the direction that allows air supplied from the drying nozzle 245 to dry the solvent 6 adhering to the nozzle 8, the charging electrode 10, the ground deflection electrode 11, the positive deflection electrode 12, and the gutter 14 which are provided in the print head 2.

The head cleaning unit 300 is capable of supplying the solvent 6, which has passed through the conduit 5 (for the head cleaning unit), from the cleaning nozzle ports 242A and 242B to the head cleaning unit interior 59 to be able to clean the print head 2. The solvent 6 used for cleaning is supplied from the solvent receiver 55 to the waste liquid container 23 through the connection path 56. In this case, the solvent 6 discharged from the cleaning nozzle ports 242A and 242B may be suctioned from the nozzle 8 inside the print head 2 by using a circulation path of the inkjet recording device main body 1. In addition, the head cleaning unit 300 is capable of supplying the air, which has passed through the conduit 5 (for the head cleaning unit), from the drying nozzle port 245A to the head cleaning unit interior 59 to be able to dry the print head 2.

FIG. 5A illustrates a cross-sectional view of the head cleaning unit 300 in a state where the container connection portion 51 of the head cleaning unit main body 50 and the waste liquid container 23 are connected to each other. FIG. 5B illustrates a cross-sectional view of the head cleaning unit 300 in a state where the waste liquid container 23 is removed from the container connection portion 51. In FIG. 5B, when the waste liquid container 23 contains the solvent 6, since the waste liquid container 23 includes the seal plug 60 which is attachable to and detachable from the waste liquid container 23, it is possible to block the atmosphere in the waste liquid container 23 from the outside air, and it is possible to prevent the solvent 6 from spilling outside from the waste liquid container 23.

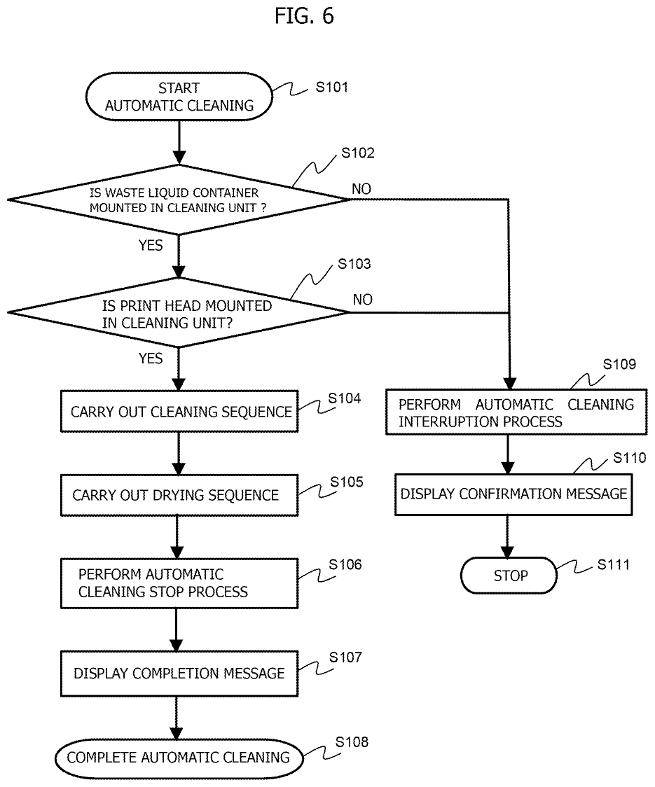

FIG. 6 illustrates an operation flow of the head cleaning unit in the present embodiment. In FIG. 6, firstly, in step 101, the operation display unit 3 provided in the inkjet recording device 400 displays a state where the function of the head cleaning unit 300 is instructed to start, and automatic cleaning starts.

Subsequently, in step 102, the sensor (for the waste liquid container) provided in the head cleaning unit 300 and the sensor provided in the waste liquid container 23 determine whether or not the waste liquid container 23 is connected to the container connection portion 51 provided in the head cleaning unit 300. When the waste liquid container 23 is not connected to the container connection portion 51, the process proceeds to step 109, and when the waste liquid container 23 is connected to the container connection portion 51, the process proceeds to step 103.

Subsequently, in step 103, the sensor (for the print head) provided in the head cleaning unit 300 and the sensor provided in the print head 2 determine whether or not the print head 2 is inserted into the insertion port 52 provided in the head cleaning unit 300. When the print head 2 is not inserted into the insertion port 52, the process proceeds to step 109, and when the print head 2 is inserted into the insertion port 52, the process proceeds to step 104.

In step 104, a cleaning sequence, in which the solvent 6 is discharged from the cleaning nozzle 242 to clean the print head 2 by using the solvent 6 or the paths inside the inkjet recording device 400 and operating the electromagnetic valves and the pumps and the solvent 6 used for cleaning is supplied to the waste liquid container 23, is carried out.

Subsequently, in step 105, a drying sequence, in which air is discharged from the drying nozzle 245 to dry the print head 2 by operating the electromagnetic valves and the pumps inside the inkjet recording device 400, is carried out.

Subsequently, in step 106, an automatic cleaning stop process of stopping the operation of the electromagnetic valves and the pumps inside the inkjet recording device 400 is performed.

Step 107 is a completion message display process of indicating an operator that the steps of steps 104 to 106 are normally performed.

Finally, in step 108, a mode where the function of the head cleaning unit 300 is normally completed is indicated and the automatic cleaning is completed.

In step 109, a mode where in step 102 and step 103, the function of the head cleaning unit 300 is determined to not be normally usable is indicated and an automatic cleaning interruption process is performed.

Step 110 is a process of indicating the operator that the procedure is in step 109, and for example, a message such as “the print head is not set in the cleaning unit” or “the waste liquid container is not set” is output. In step 111, a mode where the processes of steps 109 and 110 are performed and the procedure is stopped is indicated.

Incidentally, in step 104 and step 105, the operator may be able to select different types of sequences where the electromagnetic valves and the pumps operate differently.

As described above, in the present embodiment, there are provided the head cleaning unit including the insertion port into which the print head of the inkjet recording device is insertable, the paths that supply the cleaning liquid from the cleaning liquid container of the inkjet recording device to the head cleaning unit, the nozzle that supplies the cleaning liquid to the inside of the head cleaning unit, and the container that recovers the cleaning liquid without allowing the cleaning liquid to spill around the device.

Accordingly, it is possible to eliminate the cause of occurrence of nozzle clogging by inserting the print head 2 into the head cleaning unit 300 provided in the inkjet recording device 400, cleaning the print head 2 with the solvent thereinside, and drying the print head 2. In addition, the seal portion 54 and the seal plug 60 are capable of preventing the solvent from spilling around the device. Furthermore, since the waste liquid container 23 of which the inside is blocked from the outside air by the seal plug 60 can be removed from the head cleaning unit 300 and can be moved to another place, the operator can perform a waste liquid treatment procedure according to equipment of the operator.

Incidentally, in the above description, the head cleaning unit 300 includes the head cleaning unit main body 50 and the waste liquid container 23; however, the waste liquid container 23 may be mounted external to the head cleaning unit 300 as a separate body from the head cleaning unit 300. In addition, the head cleaning unit 300 may include an adapter to be mounted in the inkjet recording device 400 or other equipment.

In addition, in the above description, the head cleaning unit 300 includes the cleaning nozzle and the drying nozzle; however, separate units for the cleaning nozzle and for the drying nozzle may be provided.

### Second Embodiment

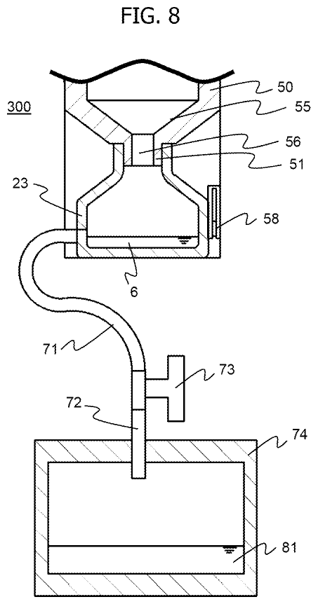

FIG. 8 is a cross-sectional view of a head cleaning unit in the present embodiment. In FIG. 8, the same reference signs are assigned to the same configurations as those in FIG. 5A, and the descriptions thereof will be omitted. FIG. 8 differs from FIG. 5A in that a waste liquid tank 74 connected to the waste liquid container 23 is provided.

FIG. 8 illustrates a cross-sectional view of the waste liquid container 23 connected to the head cleaning unit 300 and the waste liquid tank 74 connected to the waste liquid container 23. In FIG. 8, reference numerals 71 and 72 denote paths (for a waste liquid), reference numeral 73 denotes a path opening and closing cock, reference numeral 74 denotes the waste liquid tank, and reference numeral 81 denotes the waste liquid.

The head cleaning unit 300 includes the waste liquid container 23, which is connected via the paths 71 and 72 to the waste liquid tank 74, in a state where the waste liquid container 23 can be removed from the container connection portion 51. In other words, the waste liquid container 23 includes a pipe capable of exhausting the waste liquid from inside to outside. The path 71 is detachably connected to the waste liquid container 23 and the path 72 is detachably connected to the waste liquid tank 74.

In the head cleaning unit 300, when the path opening and closing cock 73 is opened, the solvent 6 in the waste liquid container 23 is allowed to be supplied to the waste liquid tank 74 via the path 71 and the path 72 by the motion of free fall.

As described above, according to the present embodiment, in the head cleaning unit 300 provided in the inkjet recording device 400, it is possible to discard the solvent 6 in the waste liquid container 23 without removing the waste liquid container 23 from the container connection portion 51. In addition, since the path 71 can be removed from the waste liquid container 23, as described in the first embodiment, it is possible to remove the waste liquid container 23 from the container connection portion 51 and perform a discard process. For this reason, the user can perform the waste liquid treatment procedure according to the equipment of the operator.

### Third Embodiment

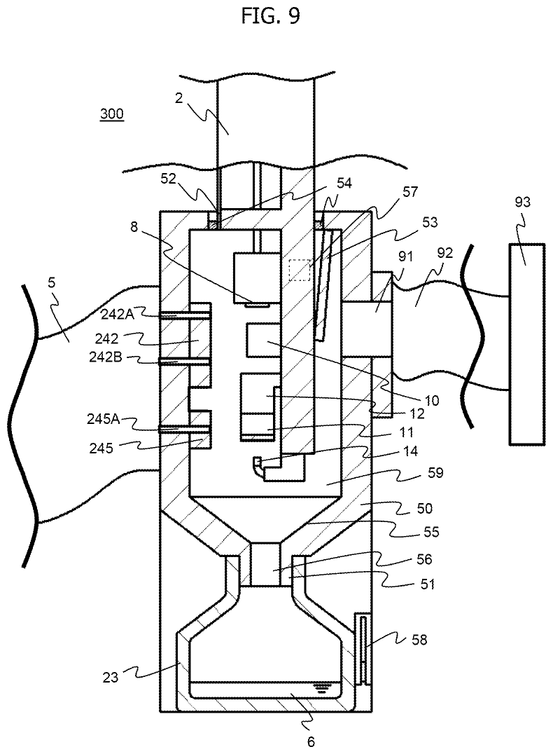

FIG. 9 is a cross-sectional view of a head cleaning unit in the present embodiment. In FIG. 9, the same reference signs are assigned to the same configurations as those in FIG. 4, and the descriptions thereof will be omitted. FIG. 9 differs from FIG. 4 in that the head cleaning unit is configured to be connectable to an external exhaust device 93.

FIG. 9 illustrates a cross-sectional view of the head cleaning unit 300 configured to be connectable to the external exhaust device 93. In FIG. 9, reference numeral 91 denotes an exhaust port, reference numeral 92 denotes a conduit (for exhaust), and reference numeral 93 denotes the external exhaust device. The head cleaning unit 300 includes the exhaust port 91, and the exhaust port 91 allows the atmosphere in the head cleaning unit interior 59 to communicate with the external exhaust device 93 via the conduit 92.

As described above, according to the present embodiment, the head cleaning unit 300 provided in the inkjet recording device 400 is capable of exhausting the atmosphere in the head cleaning unit interior 59 to outside from the path other than the exhaust path 217 of the inkjet recording device main body 1. For this reason, the user can perform an exhaust process according to the equipment of the operator.

Incidentally, the present invention is not limited to the foregoing embodiments, and includes various modification examples. For example, the foregoing embodiments have been described in detail so as to describe the present invention in an easy-to-understand manner, and the present invention is not necessarily limited to including the described all of the configurations. In addition, a part of the configuration of an embodiment can be replaced with the configuration of another embodiment, and the configuration of another embodiment can be added to the configuration of an embodiment. In addition, other configurations can be added to, removed from, or replaced with a part of the configuration of each embodiment.

### REFERENCE SIGNS LIST

1 Inkjet recording device main body
2 Print head
5 Conduit (for head cleaning unit)
6 Solvent
8 Nozzle
14 Gutter
20 Main ink container
21 Auxiliary ink container
22 Solvent container
23 Waste liquid container
30 Filter (for head cleaning unit)
38 Electromagnetic valve (for replenishment of solvent)
39 Electromagnetic valve (for cleaning)
40 Electromagnetic valve (for head cleaning unit)
41 Electromagnetic valve (for supply of air)
50 Head cleaning unit main body
51 Container connection portion
52 Insertion port
53 Head cleaning unit lid portion
54 Seal portion
55 Solvent receiver
56 Connection path
57 Sensor (for print head)
58 Sensor (for waste liquid container)
59 Head cleaning unit interior
60 Seal plug
61 Torsion coil spring
71, 72 Path (for waste liquid)
73 Path opening and closing cock
74 Waste liquid tank
81 Waste liquid
91 Exhaust port
92 Conduit (for exhaust)
93 External exhaust device
236, 237 Path (for cleaning)
239 to 241 Path (for head cleaning unit)
242 Cleaning nozzle
242A, 242B Cleaning nozzle port
243, 244 Path (for supply of air)
245 Drying nozzle
245A Drying nozzle port
246 Path (for exhaust)
300 Head cleaning unit
400 Inkjet recording device

1. An inkjet recording device comprising:
a main body including an ink container that accommodates an ink used to perform printing on a print target, and a cleaning liquid container that accommodates a cleaning liquid;
a print head including a nozzle that is connected to the ink container to discharge the ink which is pressurized and supplied, a charging electrode that charges ink particles to be used for the printing, a deflection electrode that deflects the ink particles charged by the charging electrode, and a gutter that recovers the ink particles which are not used for the printing; and
a head cleaning unit including a cleaning nozzle that discharges the cleaning liquid, and an insertion port into which the print head is insertable.

2. The inkjet recording device according to claim 1,
wherein the main body and the head cleaning unit are provided as separate bodies.

3. The inkjet recording device according to claim 1,
wherein the head cleaning unit is connected to the main body via a conduit.

4. The inkjet recording device according to claim 1,
wherein the cleaning liquid container is connected to the cleaning nozzle via a cleaning path.

5. The inkjet recording device according to claim 1,
wherein the head cleaning unit includes a container connection portion allowing the head cleaning unit to be connected to a waste liquid container that accommodates the cleaning liquid which is used for cleaning.

6. The inkjet recording device according to claim 1,
wherein head detecting means that detects whether or not the print head is inserted into the insertion port is installed in the head cleaning unit.

7. The inkjet recording device according to claim 5,
wherein the head cleaning unit includes container detecting means that detects whether or not the waste liquid container is connected to the container connection portion.

8. The inkjet recording device according to claim 1,
wherein the insertion port includes a seal portion that blocks an atmosphere in a head cleaning unit interior from an outside air.

9. The inkjet recording device according to claim 1,
wherein the head cleaning unit includes an air nozzle that discharges air.

10. An inkjet recording device comprising:
a main body including an ink container that accommodates an ink used to perform printing on a print target, and a cleaning liquid container that accommodates a cleaning liquid;
a print head including a nozzle that is connected to the ink container to discharge the ink which is pressurized and supplied, a charging electrode that charges ink particles to be used for the printing, a deflection electrode that deflects the ink particles charged by the charging electrode, and a gutter that recovers the ink particles which are not used for the printing; and
an external unit including an air nozzle that discharges air, and an insertion port into which the print head is insertable.

11. The inkjet recording device according to claim 10,
wherein the main body and the external unit are provided as separate bodies.

12. The inkjet recording device according to claim 10,
wherein the external unit is connected to the main body via a conduit.

13. The inkjet recording device according to claim 9,
wherein the air nozzle is connected to an air pump that delivers the air.

14. The inkjet recording device according to claim 9,
wherein the air nozzle is connected to a path connectable to an external air compressor that delivers the air.

15. The inkjet recording device according to claim 3,
wherein the main body is connected to the print head via a head conduit, and
the conduit is longer than the head conduit.

16. The inkjet recording device according to claim 5,
wherein the waste liquid container includes a pipe configured to exhaust a waste liquid from inside to outside.
